(19) United States
(12) Patent Application Publication
(10) Pub. No.: US 2025/0016416 A1
(43) Pub. Date: Jan. 9, 2025

(54) VIDEO EDITING METHOD AND APPARATUS, AND ELECTRONIC DEVICE

(71) Applicant: VIVO MOBILE COMMUNICATION CO., LTD., Dongguan (CN)

(72) Inventor: Yanwen ZHANG, Dongguan (CN)

(73) Assignee: VIVO MOBILE COMMUNICATION CO., LTD., Dongguan (CN)

(21) Appl. No.: 18/892,325

(22) Filed: Sep. 20, 2024

Related U.S. Application Data
(63) Continuation of application No. PCT/CN2023/082504, filed on Mar. 20, 2023.

(30) Foreign Application Priority Data
Mar. 21, 2022 (CN) 202210282085.1

(51) Int. Cl. H04N 21/472; H04N 21/4545; H04N 21/81

(52) U.S. Cl. CPC H04N 21/47205; H04N 21/4545; H04N 21/8113

(57) ABSTRACT

A video editing method, an electronic device, and a non-transitory computer readable storage medium are provided. The method includes: receiving a first input performed by a user to a video playback interface of a first video. The method further includes displaying a first identifier in response to the first input. The first identifier indicates a first video clip in the first video. The method also includes receiving a second input performed by the user. The method additionally includes storing the first identifier in response to the second input.

### CROSS-REFERENCE TO RELATED APPLICATIONS

This application is a continuation of International Application No. PCT/CN2023/082504, filed on Mar. 20, 2023, which claims priority to Chinese Patent Application No. 202210282085.1, filed on Mar. 21, 2022. The entire contents of each of the above-referenced applications are expressly incorporated herein by reference.

### TECHNICAL FIELD

This application pertains to the field of video technologies, and specifically relates to a video editing method and apparatus, and an electronic device.

### BACKGROUND

With continuous development of communication technologies, self-media is applied more widely. In daily life, people can shoot videos to record their life by using electronic devices, and then splice the videos to share with the Internet.

Usually, if a user triggers an electronic device to extract a video clip from a video, the user may trigger the electronic device to run a video editing application, so that the electronic device can extract the clip from the video by using the video editing application. Afterward, the user may trigger the electronic device to save the video clip in memory space.

### SUMMARY

An objective of embodiments of this application is to provide a video editing method and apparatus, and an electronic device to resolve a problem that large memory space of an electronic device is occupied for storing extracted video clips.

According to a first aspect, an embodiment of this application provides a video editing method. The method includes: receiving a first input performed by a user to a video playback interface of a first video; displaying a first identifier in response to the first input, where the first identifier indicates a first video clip in the first video; receiving a second input performed by the user; and storing the first identifier in response to the second input.

According to a second aspect, an embodiment of this application provides a video editing apparatus. The video editing apparatus includes a receiving module, a display module, and a storage module. The receiving module is configured to receive a first input performed by a user to a video playback interface of a first video. The display module is configured to display a first identifier in response to the first input received by the receiving module, where the first identifier indicates a first video clip in the first video. The receiving module is further configured to receive a second input performed by the user. The storage module is configured to store the first identifier in response to the second input received by the receiving module.

According to a third aspect, an embodiment of this application provides an electronic device. The electronic device includes a processor and a memory. The memory stores a program or instructions capable of running on the processor. When the program or instructions are executed by the processor, the steps of the method according to the first aspect are implemented.

According to a fourth aspect, an embodiment of this application provides a readable storage medium. The readable storage medium stores a program or instructions. When the program or instructions are executed by a processor, the steps of the method according to the first aspect are implemented.

According to a fifth aspect, an embodiment of this application provides a chip. The chip includes a processor and a communication interface. The communication interface is coupled to the processor. The processor is configured to run a program or instructions to implement the method according to the first aspect.

According to a sixth aspect, an embodiment of this application provides a computer program product. The program product is stored in a storage medium. The program product is executed by at least one processor to implement the method according to the first aspect.

In the embodiments of this application, the first input performed by the user to the video playback interface of the first video is received; the first identifier is displayed in response to the first input, where the first identifier indicates the first video clip in the first video; the second input performed by the user is received; and the first identifier is stored in response to the second input.

In this method, after the user triggers displaying of the identifier by performing the input on the video playback interface of the video, because the user can perform another input to trigger storage of the identifier indicating the video clip in the video, compared with an electronic device storing an extracted video clip in memory space, the embodiments of this application greatly save storage space by storing the identifier.

### BRIEF DESCRIPTION OF DRAWINGS

FIG. 1 is a schematic diagram of a video editing method according to an embodiment of this application;

FIGS. 2a and 2b each is a schematic diagram of a video editing interface according to an embodiment of this application;

FIG. 3 is a schematic diagram of an identifier generation interface according to an embodiment of this application;

FIG. 4 is a schematic diagram of an identifier editing interface according to an embodiment of this application;

FIG. 5 is a schematic diagram of a video parameter detail interface according to an embodiment of this application;

FIG. 6 is a schematic diagram of an identifier viewing interface according to an embodiment of this application;

FIG. 7 is a schematic diagram of a structure of a video editing apparatus according to an embodiment of this application;

FIG. 8 is a schematic diagram of a structure of an electronic device according to an embodiment of this application; and

FIG. 9 is a schematic diagram of hardware of an electronic device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

In the prior art, if a user triggers an electronic device to extract one video clip, the electronic device needs to use a large amount of storage space to store the extracted video clip. Therefore, a large amount of memory space of the electronic device is occupied, and a waste of resources is caused.

Based on the foregoing problem, embodiments of this application provide a video editing method. After a user triggers displaying of an identifier by performing an input on a video playback interface of a video, because the user can perform another input to trigger storage of the identifier indicating a video clip in the video, compared with an electronic device storing an extracted video clip in memory space, the embodiments of this application greatly save storage space.

The video editing method provided in the embodiments of this application is hereinafter described in detail by using embodiments and application scenarios thereof with reference to the accompanying drawings.

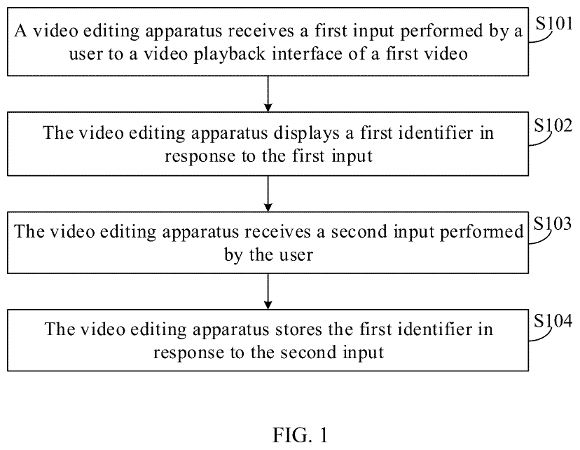

As shown in FIG. 1, an embodiment of this application provides a video editing method. The method may include the following steps S101 to S104.

S101. A video editing apparatus receives a first input performed by a user to a video playback interface of a first video.

In some embodiments, the first video may be a video played online or a video stored in an electronic device.

In some embodiments, the first input may be a touch input, voice input, or gesture input performed by the user to the video playback interface. For example, the touch input is a tap input performed by the user to the video playback interface. The first input may also be any other possible input, which is not limited in this embodiment of this application.

S102. The video editing apparatus displays a first identifier in response to the first input.

The first identifier indicates a first video clip in the first video.

In some embodiments, the identifier in this application may be a text, a symbol, an image, or the like used to indicate information, and a control or another container may be used as a carrier for displaying information. The identifier includes but is not limited to a text identifier, a symbol identifier, or an image identifier.

S103. The video editing apparatus receives a second input performed by the user.

In some embodiments, the second input may be a touch input, voice input, or gesture input performed by the user. For example, the touch input is a double-tap input performed by the user to the first identifier. For another example, the touch input is a tap input performed by the user to a save control.

S104. The video editing apparatus stores the first identifier in response to the second input.

For example, before S101, the video editing method provided in this embodiment of this application may further include: receiving a third input performed by the user to an identification control; and making the first video in an editable state in response to the third input.

It may be understood that, after triggering the first video to be in the editable state by performing an input on the identification control, the user may trigger the setting of the identifier based on an actual requirement.

For example, the video editing apparatus is a mobile phone. It is assumed that the mobile phone is playing a video 1. In a case that the mobile phone displays a video playback interface of the video 1, the user may tap an image frame of the video 1. After the mobile phone receives the tap input, an identifier 1 may be displayed in response to the tap input. Next, if the user wants to store the identifier, the user may tap a save control. When the mobile phone receives the tap input on the save control, the mobile phone may respond to the tap input and store the identifier 1.

In the video editing method provided in this embodiment of this application, after the user triggers displaying of the identifier by performing the input on the video playback interface of the video, because the user can perform another input to trigger storage of the identifier indicating the video clip in the video, compared with an electronic device storing an extracted video clip in memory space, this embodiment of this application greatly saves storage space.

In some embodiments, the first input includes a first sub-input and a second sub-input; and correspondingly, S101 may be implemented by the following S101A, and S102 may include S102A and S102B.

S101A. The video editing apparatus receives the first sub-input performed by the user to a first image frame in the first video and the second sub-input performed by the user to a second image frame in the first video.

In some embodiments, in a case that the video playback interface of the first video includes a play progress bar, the first sub-input is an input of a first play node on the play progress bar, and the first play node corresponds to the first image frame; and the second sub-input is an input of a second play node on the play progress bar, and the second play node corresponds to the second image frame.

It should be noted that the first input includes the first sub-input and the second sub-input. For example, the first sub-input may be performed first, and then the second sub-input is performed; or the second sub-input may be performed first, and then the first sub-input is performed; or the first sub-input and the second sub-input may be performed simultaneously. This may be determined based on actual usage, and is not limited in this embodiment of this application.

S102A. The video editing apparatus displays a start marker point in response to the first sub-input.

In some embodiments, in a possible case, the first image frame corresponds to the start marker point; or in another possible case, the second image frame corresponds to the start marker point.

S102B. The video editing apparatus displays an end marker point and the first identifier in response to the second sub-input.

The first video clip is a video clip between the first image frame and the second image frame, and the first identifier is determined based on the start marker point and the end marker point.

In some embodiments, if the first image frame corresponds to the start marker point, the second image frame corresponds to the end marker point; or if the second image frame corresponds to the start marker point, the first image frame corresponds to the end marker point.

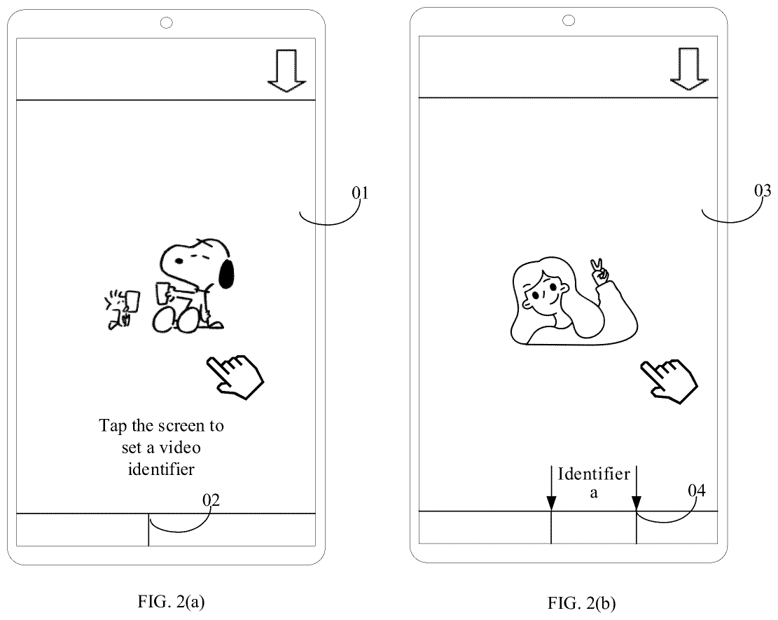

In an example 1, the video editing apparatus is a mobile phone. The mobile phone is playing a cartoon (that is, the first video). As shown in FIG. 2(a), the mobile phone displays an image frame 01 (that is, the first image frame) of the first video. In a case that the first video is in an editing state, the user may tap the image frame 01; and after the mobile phone receives the tap input, the mobile phone may display a start marker point 02. Then, as shown in FIG. 2(b), when the mobile phone plays an image frame 03 of the first video (that is, the second image frame), the user taps the image frame 03 again. After the mobile phone receives the tap input on the image frame 03, the mobile phone may display an end marker point 04 and an identifier a (that is, the first identifier) in response to the tap input.

In the video editing method provided in this embodiment of this application, the user can trigger displaying of the start marker point and displaying of the end marker point and the first identifier by performing inputs on the first image frame and the second image frame. Therefore, the electronic device can store the first identifier in the storage space, thereby saving large memory space required for storing the extracted video clip.

For example, after S102B, the video editing method provided in this embodiment of this application may further include the following S105 and S106.

S105. The video editing apparatus receives a fourth input performed by the user to a target marker point.

The target marker point includes at least one of the following: the start marker point and the end marker point.

In some embodiments, the fourth input may be a touch input, voice input, or gesture input performed by the user to the target marker point. For example, the touch input is a drag input performed by the user to the target marker point. The fourth input may also be any other possible input, which is not limited in this embodiment of this application.

S106. The video editing apparatus updates, in response to the fourth input, a location of the target marker point and the first video clip indicated by the first identifier.

It should be noted that after the fourth input on the target marker point is received, an image frame corresponding to the location-updated target marker point changes accordingly, and further, the image frame included in the first video clip indicated by the first identifier also changes.

In this embodiment of this application, the user can perform an input on the target marker point to trigger updating of the location of the target marker point and the first video clip indicated by the first identifier, so that the user can update, based on an actual requirement, the video clip indicated by the identifier. In addition, an operation of editing the video clip during video production process is simplified to an operation to the identifier.

For example, after S104, the video editing method provided in this embodiment of this application may further include the following S107 and S108.

S107. The video editing apparatus receives a fifth input performed by the user to the first identifier.

In some embodiments, the fifth input may be a touch input, voice input, or gesture input performed by the user to the first identifier. For example, the touch input is a double-tap input performed by the user to the first identifier. The fifth input may also be any other possible input, which is not limited in this embodiment of this application.

S108. The video editing apparatus displays a first editing window of the first video clip in response to the fifth input.

The first editing window is used to update video parameter information of the first video clip.

In some embodiments, the first editing window may include at least one of the following controls: a filter control, a text control, and a background music control. The filter control is used to update filter information of the first video clip, the text control is used to update text information of the first video clip, and the background music control is used to update background music of the first video clip.

In some embodiments, the video parameter information may include at least one of the following: filter information, background music, text information, text displaying and disappearing animation effect information, and the like.

For example, it is assumed that the first editing window includes the filter control. When the user taps the filter control, popping of a filter selection list may be triggered, so that the user can select a filter parameter from the filter selection list. Therefore, the video editing apparatus can update filter information of the first identifier to filter information corresponding to the filter parameter.

It may be understood that the video editing apparatus may generate the first identifier based on the first image frame, the second image frame, and the video parameter information.

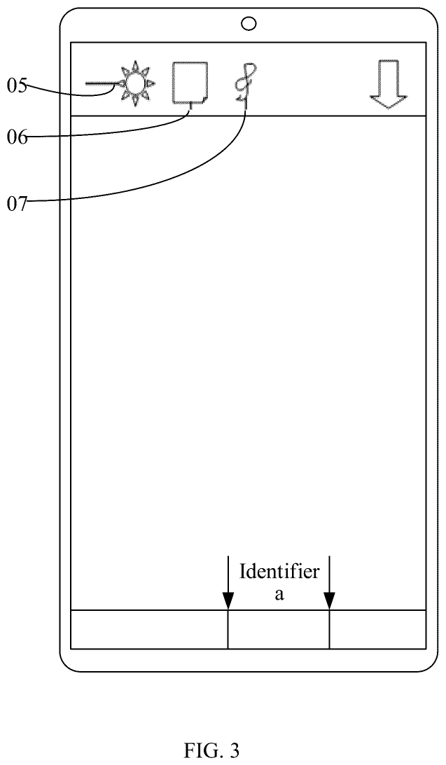

In an example 2, the video editing apparatus is a mobile phone. With reference to FIG. 2, the user taps an identifier a. After the mobile phone receives the tap input on the identifier a, the mobile phone displays an editing window in response to the input, as shown in FIG. 3, where the editing window includes a control 05, a control 06, and a control 07. Because the control 05 is used to update filter information of a video clip indicated by the identifier a, the user may tap the control 05; and after the mobile phone receives the tap input on the control 05, a filter of the first video clip is set in response to the tap input.

For example, after S108, the video editing method provided in this embodiment of this application may further include: the video editing apparatus receives an input on the first identifier; and plays the first video clip with updated video parameter information in response to the input. In this way, an image effect of a video clip can be quickly changed according to wishes of the user.

It should be noted that in the process of playing the first video, if an operation is performed on the first identifier, the first video clip with the updated video parameter information is played; conversely, if no operation is performed on the first identifier, the first video clip with the original video parameter information is played.

In the video editing method provided in this embodiment of this application, because the user can trigger the displaying of the first editing window by performing the input on the first identifier, the user can trigger updating of the video parameter information of the first video clip based on a requirement. In addition, the video editing operation during video production is simplified to the operation to the identifier.

In some embodiments, the foregoing S104 may be implemented by the following S104A.

S104A. The video editing apparatus stores, in an identification folder in an album, a first identification thumbnail corresponding to the first identifier.

For example, after the user triggers, with reference to S105 and S106 in the foregoing embodiment, generation of the first identifier indicating the video clip, an identification folder may be created in the album. It should be noted that the identification folder is used to store an identification thumbnail, and the identification thumbnail corresponds to a video clip in the video.

In some embodiments, the identification folder may further include a second identification thumbnail corresponding to a second identifier, and the second identifier is used to indicate a second video clip in the first video, where video image frames in the second video clip are different from video image frames in the first video clip, or video image frames in the second video clip are partially the same as video image frames in the first video clip.

It may be understood that after the first identifier is generated, the first identification thumbnail corresponding to the first identifier may be added to the identification folder of the album, so that occupancy of excessive memory space due to repeated storage of reusable video clips can be avoided.

For example, after S104A, the video editing method provided in this embodiment of this application may further include the following S109 to S112.

S109. The video editing apparatus receives a sixth input performed by the user to the identification folder.

In some embodiments, the sixth input may be a touch input, voice input, or gesture input performed by the user to the identification folder. For example, the touch input is a tap input performed by the user to the identification folder. The sixth input may also be any other possible input, which is not limited in this embodiment of this application.

S110. The video editing apparatus displays P identification thumbnails and a video editing control in response to the sixth input.

The P identification thumbnails include the first identification thumbnail, and P is a positive integer.

In some embodiments, a shape of the video editing control may be circular, rectangular, or other possible shapes; a size of the video editing control may be a preset size; and the video editing control may be displayed in any blank area of a folder interface corresponding to the identification folder. A display form of the editing control is not limited in this embodiment of this application.

S111. The video editing apparatus receives a seventh input performed by the user to the video editing control.

In some embodiments, the seventh input may be a touch input, voice input, or gesture input performed by the user to the video editing control. For example, the touch input is a tap input performed by the user to the video editing control. The seventh input may also be any other possible input, which is not limited in this embodiment of this application.

S112. The video editing apparatus displays a video editing interface in response to the seventh input.

In this embodiment of this application, because displaying of the P identification thumbnails and the video editing control can be triggered by the input performed by the user to the identification folder, the user can view the identification thumbnails; and then, because displaying of the video editing interface can be triggered by performing another input on the video editing control, the user can conveniently trigger video splicing in the video editing interface.

For example, the video editing interface includes a first display area and a second display area, the first display area includes at least one video thumbnail, each video thumbnail corresponds to a video clip, and the second display area includes at least one identification thumbnail; and correspondingly, after S112, the video editing method provided in this embodiment of this application may further include the following S113 to S115.

S113. The video editing apparatus receives an eighth input performed by the user to a target video thumbnail of the at least one video thumbnail, and receives a ninth input performed by the user to a target identification thumbnail of the at least one identification thumbnail.

In some embodiments, the eighth input may be a touch input, voice input, or gesture input performed by the user to the target video thumbnail. For example, the touch input is a tap input performed by the user to the target video thumbnail. The eighth input may also be any other possible input, which is not limited in this embodiment of this application.

In some embodiments, the ninth input may be a touch input, voice input, or gesture input performed by the user to the target identification thumbnail. For example, the touch input is a tap input performed by the user to the target identification thumbnail. The ninth input may also be any other possible input, which is not limited in this embodiment of this application.

In some embodiments, a quantity of the target video thumbnails and a quantity of target identification thumbnails are both at least one.

S114. The video editing apparatus displays the target video thumbnail and the target identification thumbnail in a third display area of the video editing interface in response to the eighth input and the ninth input.

An arrangement order of the target video thumbnail and the target identification thumbnail is in an association relationship with the eighth input and the ninth input.

In some embodiments, the arrangement order of the target video thumbnail and the target identification thumbnail is determined based on an input order of the eighth input and the ninth input.

For example, if the eighth input is performed first and then the ninth input is performed, the arrangement order of the target video thumbnail and the target identification thumbnail is: target video thumbnail, target identification thumbnail; or if the ninth input is performed first and then the eighth input is performed, the arrangement order of the target video thumbnail and the target identification thumbnail is: target identification thumbnail, target video thumbnail.

S115. The video editing apparatus generates a target video based on a third video clip corresponding to the target video thumbnail and a fourth video clip corresponding to the target identification thumbnail.

In some embodiments, S115 may include: the video editing apparatus splices a last frame in the third video clip with a first frame in the fourth video clip to obtain the target video.

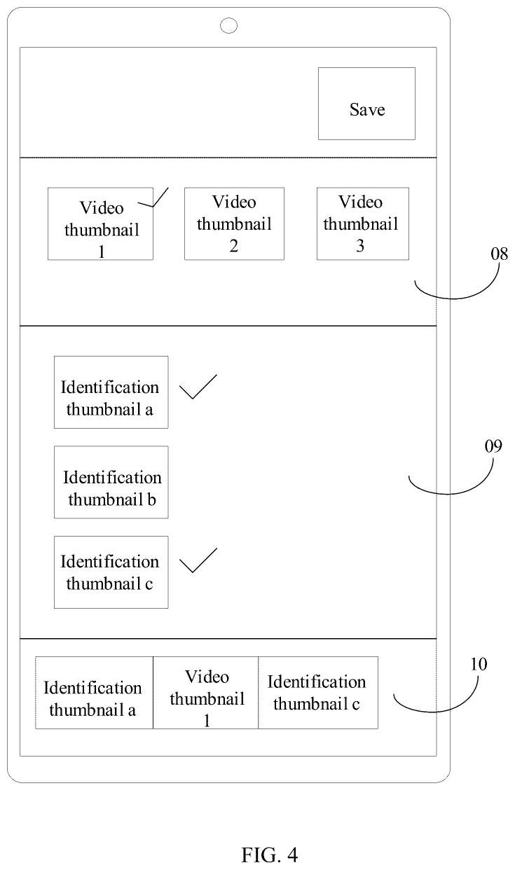

For example, the video editing apparatus is a mobile phone. As shown in FIG. 4, the mobile phone displays a video editing interface, where a display area 08 of the video editing interface includes a video thumbnail 1, a video thumbnail 2, and a video thumbnail 3, and a display area 09 of the video editing interface includes an identification thumbnail a, an identification thumbnail b, and an identification thumbnail c. If the user wants to trigger the mobile phone to perform video splicing, the user may tap the video thumbnail 1, the identification thumbnail a, and the identification thumbnail c; and after the mobile phone receives the tap inputs on the three thumbnails (that is, the eighth input and the ninth input), the mobile phone may display the three thumbnails in a display area 10 in response to the tap inputs. Afterward, the mobile phone may generate the target video based on the three video clips.

Further, the video editing apparatus may splice the third video clip and the fourth video clip in a target order to obtain a target video.

The target order includes either of the following: a selection order of the third video clip and the fourth video clip, and an arrangement order of the third video clip and the fourth video clip.

For example, the target order is the selection order of the third video clip and the fourth video clip. As shown in FIG. 4, the target order is an order of tapping the identification thumbnail a, the video thumbnail 1, and the identification thumbnail c by the user, that is, the selection order of the three thumbnails.

For example, the target order is the arrangement order of the third video clip and the fourth video clip. As shown in FIG. 4, after the video thumbnail 1, the identification thumbnail a, and the identification thumbnail c are selected, the video thumbnail 1, the identification thumbnail a, and the identification thumbnail c may be displayed in the third display area 10 of the video editing interface, that is, the target order is the arrangement order of the three thumbnails in the third display area 10.

It may be understood that because the target video can be obtained by splicing N video clips in the target order, after the user adjusts the target order based on an actual requirement, different target videos can be obtained by splicing the N video clips in an adjusted target order. In this way, user experience is improved.

In the video editing method provided in this embodiment of this application, because the at least one video thumbnail and at least one identification thumbnail are displayed in the video editing interface, when the user wants to trigger the electronic device to perform video splicing, as long as the user selects the target video thumbnail and the target identification thumbnail from the at least one video thumbnail and the at least one identification thumbnail based on a requirement, the electronic device can be triggered to obtain the target video based on at least two video clips, without requiring the user to frequently trigger interface switching of the electronic device to add a video to be spliced, thereby simplifying an operation process of video splicing by the electronic device.

For example, after S114, the video editing method provided in this embodiment of this application may further include the following S116 and S117.

S116. The video editing apparatus receives a tenth input performed by the user to the third display area.

In some embodiments, the tenth input may be a touch input, voice input, or gesture input performed by the user to the third display area. For example, the touch input is a movement input performed by the user to the third display area.

S117. The video editing apparatus updates display information of the third display area in response to the tenth input.

The display information includes at least one of the following: a quantity of target video thumbnails, locations of target video thumbnails, a quantity of target identification thumbnails, and locations of target identification thumbnails.

In some embodiments, the display information may further include: an arrangement order of the target video thumbnail and the target identification thumbnail in the third display area.

In this embodiment of this application, because the user can trigger updating of the display information of the third display area by performing the input on the third display area, the user adjusts the video clips to be spliced to obtain a target video that meets a requirement of the user.

For example, after S104A, the video editing method provided in this embodiment of this application may further include the following S118 and S119.

S118. The video editing apparatus receives an eleventh input performed by the user to the first identification thumbnail.

In some embodiments, the eleventh input may be a touch input, voice input, or gesture input performed by the user to the first identification thumbnail. For example, the touch input is a tap input performed by the user to the first identification thumbnail. The eleventh input may also be any other possible input, which is not limited in this embodiment of this application.

S119. The video editing apparatus displays a target interface in response to the eleventh input.

The target interface includes video parameter information of the first video clip.

In some embodiments, the target interface may further include at least one of the following: information about the original video of the first video clip corresponding to the first identification thumbnail, and timestamp information of the first video clip corresponding to the first identification thumbnail.

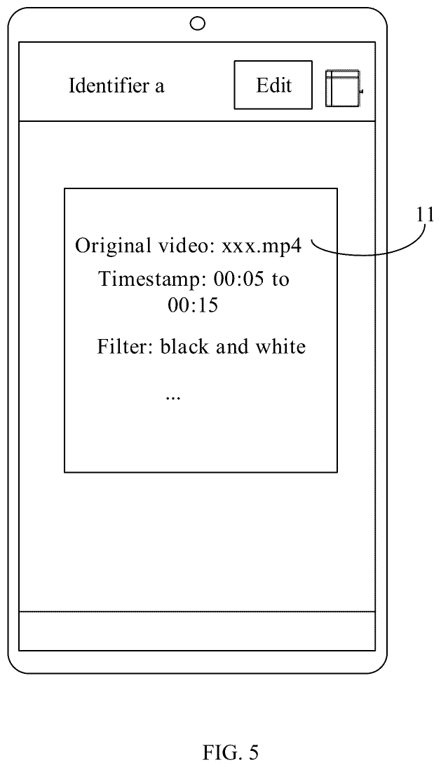

For example, the video editing apparatus is a mobile phone. If the user taps the identification thumbnail a, after the mobile phone receives the tap input, as shown in FIG. 5, the mobile phone may display video parameter information 11 of the first video clip corresponding to the identification thumbnail a. The video parameter information 11 includes information such as

“Original video: xxx.mp4, timestamp: 00:05 to 00:15, filter: black and white”.

In this embodiment of this application, by performing the input on the identification thumbnail, the user can trigger displaying of the video parameter information of the video clip corresponding to the identification thumbnail, so that the user can know the information such as the filter, text, and background music of the video clip.

For example, after S119, the video editing method provided in this embodiment of this application may further include the following S120 and S121.

S120. The video editing apparatus receives a twelfth input performed by the user.

In some embodiments, the twelfth input may be a touch input, voice input, or gesture input performed by the user to the first identification thumbnail. For example, the touch input is a tap input performed by the user to the first identification thumbnail.

S121. The video editing apparatus updates target information in response to the twelfth input.

The target information includes at least one of the following: the video parameter information of the first video clip, and the first video clip.

In this embodiment of this application, in a case that the target interface of the first identification thumbnail is displayed, the user can trigger updating of the target information by performing the input. Therefore, when a video clip indicated by an identifier or video parameter information of the video clip does not meet the requirement of the user, the user can trigger updating of the video clip or the video parameter information of the video clip by performing an operation to the target interface.

For example, the video editing method provided in this embodiment of this application may further include the following S122 and S123.

S122. The video editing apparatus receives a thirteenth input performed by the user to the video playback interface of the first video.

In some embodiments, the thirteenth input may be a touch input, voice input, or gesture input performed by the user to the video playback interface. For example, the touch input is a tap input performed by the user to the identification control. The thirteenth input may also be any other possible input, which is not limited in this embodiment of this application.

S123. The video editing apparatus displays S identifiers of the first video in response to the thirteenth input.

Each identifier indicates a video clip in the first video, and S is a positive integer.

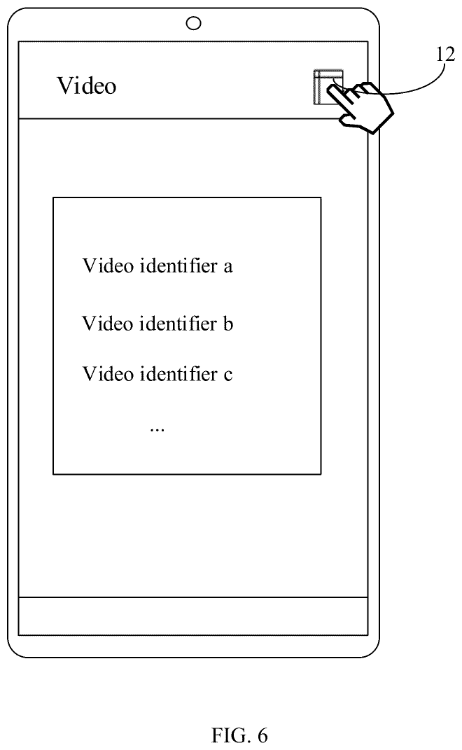

For example, the video editing apparatus is a mobile phone. As shown in FIG. 6, the playback interface of the first video is displayed, and the playback interface includes an identification control 12. If the user wants to view the identifier of the first video, the user may tap the identification control 12. After the mobile phone receives the tap input, the mobile phone may display a video identifier a, a video identifier b, . . . , and other identifiers in response to the tap input, as shown in FIG. 6.

In the video editing method provided in this embodiment of this application, the user can trigger, by performing an input on a video playback interface of a video, displaying of all identifiers included in the video. In this way, the user can view the identifier while playing the video.

For example, after S123, the video editing method provided in this embodiment of this application may further include the following S124 and S125.

S124. The video editing apparatus receives a fourteenth input performed by the user to a target identifier of the S identifiers.

In some embodiments, the fourteenth input may be a touch input, voice input, or gesture input performed by the user to the target identifier. For example, the touch input is a tap input performed by the user to the target identifier. The fourteenth input may also be any other possible input, which is not limited in this embodiment of this application.

In some embodiments, the target identifier is any one of the S identifiers. The target identifier may be the first identifier, or any other identifier than the first identifier of the S identifiers.

S125. The video editing apparatus displays, in response to the fourteenth input, a second editing window of a fifth video clip indicated by the target identifier.

The second editing window is used to update video parameter information of the third video clip.

In some embodiments, the fourteenth input may include a sub-input and another sub-input. Correspondingly, S124 may include: the video editing apparatus receives a sub-input performed to the target identifier; and displays an identification interface of the target identifier in response to the sub-input, where the identification interface includes an identification editing control.

Correspondingly, S125 may include: the video editing apparatus receives a second sub-input performed to the identification editing control; and displays, in response to the second sub-input, the second editing window of the fifth video clip indicated by the target identifier.

For example, with reference to FIG. 6, in a case that a plurality of identifiers such as the video identifier a and video identifier b are displayed, the user taps the video identifier a. After the mobile phone receives the tap input, the mobile phone may display, in response to the tap input, an editing window of the video clip indicated by the video identifier a, as shown in FIG. 3.

In the video editing method provided in this embodiment of this application, an input is performed to one of the plurality of identifiers to trigger displaying of an editing window of a video clip indicated by the identifier, so that video parameter information of the video clip can be edited. In this way, another way to enter the editing window is provided, and it is also convenient for the user to enter the editing window from different entrances to edit and update the video parameter information.

The video editing method provided in this embodiment of this application may be performed by a video editing apparatus. A video editing apparatus provided in an embodiment of this application is described by using an example in which the video editing apparatus performs the video editing method in this embodiment of this application.

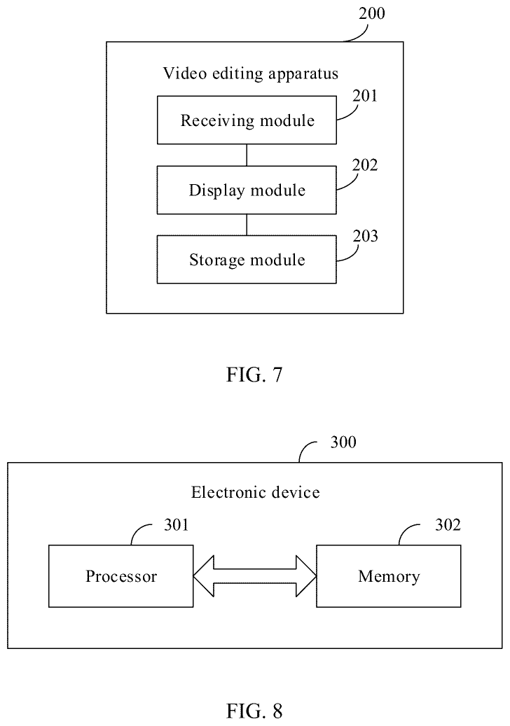

As shown in FIG. 7, an embodiment of this application provides a video editing apparatus 200. The video editing apparatus may include a receiving module 201, a display module 202, and a storage module 203. The receiving module 201 may be configured to receive a first input performed by a user to a video playback interface of a first video. The display module 202 may be configured to display a first identifier in response to the first input received by the receiving module 201, where the first identifier indicates a first video clip in the first video. The receiving module 201 may be further configured to receive a second input performed by the user. The storage module 203 may be configured to store the first identifier in response to the second input received by the receiving module 201.

In some embodiments, the video editing apparatus may further include a processing module. The receiving module 201 may be further configured to receive a third input performed by the user to an identification control. The processing module may be configured to make the first video in an editable state in response to the third input received by the receiving module.

In some embodiments, the first input may include a first sub-input and a second sub-input. The receiving module 201 may be configured to receive the first sub-input performed by the user to a first image frame in the first video and the second sub-input performed by the user to a second image frame in the first video. The display module 202 may be configured to display a start marker point in response to the first sub-input, and display an end marker point and the first identifier in response to the second sub-input, where the first video clip is a video clip between the first image frame and the second image frame, and the first identifier is determined based on the start marker point and the end marker point.

In some embodiments, the video editing apparatus may further include a processing module. The receiving module 201 may be further configured to receive a fourth input performed by the user to a target marker point, where the target marker point includes at least one of the following: the start marker point and the end marker point. The processing module may be configured to update, in response to the fourth input received by the receiving module, a location of the target marker point and the first video clip indicated by the first identifier.

In some embodiments, the receiving module 201 may be further configured to receive a fifth input performed by the user to the first identifier. The display module 202 may be configured to display a first editing window of the first video clip in response to the fifth input, where the first editing window is used to update video parameter information of the first video clip.

In some embodiments, the first editing window includes at least one of the following controls: a filter control, a text control, and a background music control, where the filter control is used to update filter information of the first video clip, the text control is used to update text information of the first video clip, and the background music control is used to update background music of the first video clip.

In some embodiments, the storage module 203 may be configured to store, in an identification folder in an album, a first identification thumbnail corresponding to the first identifier.

In some embodiments, the identification folder may further include a second identification thumbnail corresponding to a second identifier, and the second identifier is used to indicate a second video clip in the first video, where video image frames in the second video clip are different from video image frames in the first video clip, or video image frames in the second video clip are partially the same as video image frames in the first video clip.

In some embodiments, the receiving module 201 may be further configured to receive a sixth input performed by the user to the identification folder. The display module 202 may be further configured to display P identification thumbnails and a video editing control in response to the sixth input received by the receiving module, where the P identification thumbnails include the first identification thumbnail, and P is a positive integer. The receiving module may be further configured to receive a seventh input performed by the user to the video editing control. The display module 202 may be further configured to display a video editing interface in response to the seventh input received by the receiving module.

In some embodiments, the video editing interface may include a first display area and a second display area, the first display area includes at least one video thumbnail, each video thumbnail corresponds to a video clip, and the second display area includes at least one identification thumbnail; and the video editing apparatus may further include a processing module. The receiving module 201 may be further configured to receive an eighth input performed by the user to a target video thumbnail of the at least one video thumbnail, and receive a ninth input performed by the user to a target identification thumbnail of the at least one identification thumbnail. The display module 202 may be further configured to display the target video thumbnail and the target identification thumbnail in a third display area of the video editing interface in response to the eighth input and the ninth input received by the receiving module, where a display order of the target video thumbnail and the target identification thumbnail is in an association relationship with the eighth input and the ninth input. The processing module may be configured to generate a target video based on video clips corresponding to the target video thumbnail and the target identification thumbnail.

In some embodiments, the receiving module 201 may be further configured to receive a tenth input performed by the user to the third display area. The processing module may be further configured to update display information of the third display area in response to the tenth input received by the receiving module, where the display information includes at least one of the following: a quantity of target video thumbnails, locations of target video thumbnails, a quantity of target identification thumbnails, and locations of target identification thumbnails.

In some embodiments, the receiving module 201 may be further configured to receive an eleventh input performed by the user to the first identification thumbnail. The display module 202 may be further configured to display a target interface in response to the eleventh input received by the receiving module, where the target interface includes video parameter information of the first video clip.

In some embodiments, the receiving module 201 may be further configured to receive a twelfth input performed by the user. The processing module may be further configured to update target information in response to the twelfth input, where the target information includes at least one of the following: the video parameter information of the first video clip, and the first video clip.

In some embodiments, the receiving module 201 may be further configured to receive a thirteenth input performed by the user to the video playback interface of the first video. The display module may be further configured to display S identifiers of the first video in response to the thirteenth input received by the receiving module, where each identifier corresponds to a video clip in the first video, and S is a positive integer.

In some embodiments, the receiving module 201 may be further configured to receive a fourteenth input performed by the user to a target identifier of the S identifiers. The display module 202 may be further configured to display, in response to the fourteenth input received by the receiving module, a second editing window of a fifth video clip indicated by the target identifier, where the second editing window is used to update video parameter information of the fifth video clip.

By using the video editing apparatus provided in this embodiment of this application, after the user triggers displaying of the identifier by performing the input on the video playback interface of the video, because the user can perform another input to trigger storage of the identifier indicating the video clip in the video, compared with an electronic device storing an extracted video clip in memory space, this embodiment of this application greatly saves storage space.

The video editing apparatus in this embodiment of this application may be an electronic device, or may be a component such as an integrated circuit or a chip in an electronic device. The electronic device may be a terminal, or may be other devices than a terminal. For example, the electronic device may be a mobile phone, a tablet computer, a notebook computer, a palmtop computer, an in-vehicle electronic device, a Mobile Internet Device (MID), an Augmented Reality (AR) or Virtual Reality (VR) device, a robot, a wearable device, an Ultra-Mobile Personal Computer (UMPC), a netbook, a personal digital assistant (personal digital assistant, PDA), or the like; or the electronic device may be a server, a Network Attached Storage (NAS), a Personal Computer (PC), a Television (TV), a teller machine, a self-service machine, or the like. This is not limited in this embodiment of this application.

The video editing apparatus in this embodiment of this application may be an apparatus having an operating system. The operating system may be an Android operating system, an iOS operating system, or other possible operating systems, and is not limited in this embodiment of this application.

The video editing apparatus provided in this embodiment of this application can implement each process implemented by the method embodiments in FIG. 1 to FIG. 6, with the same technical effect achieved. To avoid repetition, details are not described herein again.

For example, as shown in FIG. 8, an embodiment of this application further provides an electronic device 300, including a processor 301 and a memory 302, where the memory 302 stores a program or instructions capable of running on the processor 301. When the program or instructions are executed by the processor 301, each step of the foregoing embodiment of the video editing method is implemented, with the same technical effect achieved. To avoid repetition, details are not described herein again.

It should be noted that electronic devices in this embodiment of this application include the foregoing mobile electronic device and nonmobile electronic device.

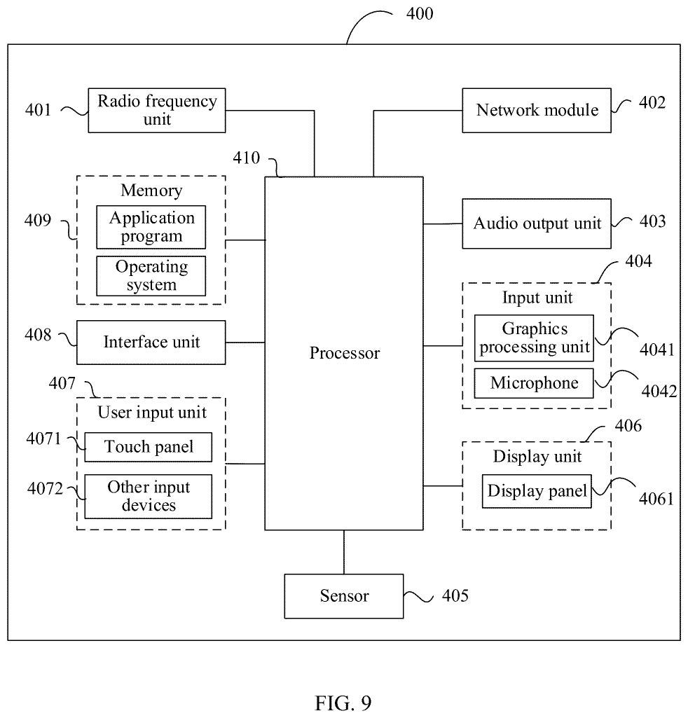

FIG. 9 is a schematic diagram of a hardware structure of an electronic device for implementing an embodiment of this application.

The electronic device 400 includes but is not limited to components such as a radio frequency unit 401, a network module 402, an audio output unit 403, an input unit 404, a sensor 405, a display unit 406, a user input unit 407, an interface unit 408, a memory 409, and a processor 410.

A person skilled in the art may understand that the electronic device 400 may further include a power supply (such as a battery) for supplying power to the components. The power supply may be logically connected to the processor 410 through a power management system. In this way, functions such as charge management, discharge management, and power consumption management are implemented by using the power management system. The structure of the electronic device shown in FIG. 9 does not constitute a limitation on the electronic device. The electronic device may include more or fewer components than those shown in the figure, or some components are combined, or component arrangements are different. Details are not described herein again.

The user input unit 407 may be configured to receive a first input performed by a user to a video playback interface of a first video. The display unit 406 may be configured to display a first identifier in response to the first input received by the user input unit, where the first identifier indicates a first video clip in the first video. The user input unit 407 may be further configured to receive a second input performed by the user. The memory 409 may be configured to store the first identifier in response to the second input received by the user input unit.

In some embodiments, the user input unit 407 may be further configured to receive a third input performed by the user to an identification control. The processor 410 may be configured to make the first video in an editable state in response to the third input received by the user input unit.

In some embodiments, the first input may include a first sub-input and a second sub-input. The user input unit 407 may be configured to receive the first sub-input performed by the user to a first image frame in the first video and the second sub-input performed by the user to a second image frame in the first video. The display unit 406 may be configured to display a start marker point in response to the first sub-input, and display an end marker point and the first identifier in response to the second sub-input, where the first video clip is a video clip between the first image frame and the second image frame, and the first identifier is determined based on the start marker point and the end marker point.

In some embodiments, the user input unit 407 may be further configured to receive a fourth input performed by the user to a target marker point, where the target marker point includes at least one of the following: the start marker point and the end marker point. The processor 410 may be configured to update, in response to the fourth input received by the user input unit 407, a location of the target marker point and the first video clip indicated by the first identifier.

In some embodiments, the user input unit 407 may be further configured to receive a fifth input performed by the user to the first identifier. The display unit 406 may be configured to display a first editing window of the first video clip in response to the fifth input, where the first editing window is used to update video parameter information of the first video clip.

In some embodiments, the memory 409 may be configured to store, in an identification folder in an album, a first identification thumbnail corresponding to the first identifier.

In some embodiments, the user input unit 407 may be further configured to receive a sixth input performed by the user to the identification folder. The display unit 406 may be further configured to display P identification thumbnails and a video editing control in response to the sixth input received by the user input unit 407, where the P identification thumbnails include the first identification thumbnail, and P is a positive integer. The user input unit 407 may be further configured to receive a seventh input performed by the user to the video editing control. The display unit 406 may be further configured to display a video editing interface in response to the seventh input received by the user input unit 407.

In some embodiments, the video editing interface may include a first display area and a second display area, the first display area includes at least one video thumbnail, each video thumbnail corresponds to a video clip, and the second display area includes at least one identification thumbnail. The user input unit 407 may be further configured to receive an eighth input performed by the user to a target video thumbnail of the at least one video thumbnail, and receive a ninth input performed by the user to a target identification thumbnail of the at least one identification thumbnail. The display unit 406 may be further configured to display the target video thumbnail and the target identification thumbnail in a third display area of the video editing interface in response to the eighth input and the ninth input received by the user input unit 407, where a display order of the target video thumbnail and the target identification thumbnail is in an association relationship with the eighth input and the ninth input. The processor 410 may be configured to generate a target video based on video clips corresponding to the target video thumbnail and the target identification thumbnail.

In some embodiments, the user input unit 407 may be further configured to receive a tenth input performed by the user to the third display area. The processor 410 may be further configured to update display information of the third display area in response to the tenth input received by the user input unit 407, where the display information includes at least one of the following: a quantity of target video thumbnails, locations of target video thumbnails, a quantity of target identification thumbnails, and locations of target identification thumbnails.

In some embodiments, the user input unit 407 may be further configured to receive an eleventh input performed by the user to the first identification thumbnail. The display unit 406 may be further configured to display a target interface in response to the eleventh input received by the user input unit 407, where the target interface includes video parameter information of the first video clip.

In some embodiments, the user input unit 407 may be further configured to receive a twelfth input performed by the user. The processor 410 may be further configured to update target information in response to the twelfth input, where the target information includes at least one of the following: the video parameter information of the first video clip, and the first video clip.

In some embodiments, the user input unit 407 may be further configured to receive a thirteenth input performed by the user to the video playback interface of the first video. The display unit 406 may be further configured to display S identifiers of the first video in response to the thirteenth input received by the user input unit 407, where each identifier corresponds to a video clip in the first video, and S is a positive integer.

In some embodiments, the user input unit 407 may be further configured to receive a fourteenth input performed by the user to a target identifier of the S identifiers. The display unit 406 may be further configured to display, in response to the fourteenth input received by the user input unit 407, a second editing window of a fifth video clip indicated by the target identifier, where the second editing window is used to update video parameter information of the fifth video clip.

By using the electronic device provided in this embodiment of this application, after the user triggers displaying of the identifier by performing the input on the video playback interface of the video, because the user can perform another input to trigger storage of the identifier indicating the video clip in the video, compared with an electronic device storing an extracted video clip in memory space, this embodiment of this application greatly saves storage space.

It should be understood that, in this embodiment of this application, the input unit 404 may include a Graphics Processing Unit (GPU) 4041 and a microphone 4042. The GPU 4041 processes image data of a still picture or video obtained by an image capture apparatus (such as a camera) in a video capture mode or an image capture mode. The display unit 406 may include a display panel 4061, and the display panel 4061 may be configured in a form of a liquid crystal display, an organic light-emitting diode, or the like. The user input unit 407 includes at least one of a touch panel 4071 and other input devices 4072. The touch panel 4071 is also referred to as a touchscreen. The touch panel 4071 may include two parts: a touch detection apparatus and a touch controller. The other input devices 4072 may include but are not limited to a physical keyboard, a function button (such as a volume control button or a power button), a trackball, a mouse, and a joystick. Details are not described herein again.

The memory 409 may be configured to store software programs and various data. The memory 409 may primarily include a first storage area for storing programs or instructions and a second storage area for storing data. The first storage area may store an operating system, an application or instructions required by at least one function (such as an audio play function and an image play function), and the like. In addition, the memory 409 may include a volatile memory or a non-volatile memory, or the memory 409 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 409 in this embodiment of this application includes but is not limited to these and any other suitable types of memories.

The processor 410 may include one or more processing units. In some embodiments, the processor 410 integrates an application processor and a modem processor. The application processor mainly processes operations related to the operating system, a user interface, an application, and the like. The modem processor mainly processes a wireless communication signal. For example, the modem processor is a baseband processor. It may be understood that the modem processor may not be integrated in the processor 410.

An embodiment of this application further provides a readable storage medium. The readable storage medium stores a program or instructions. When the program or instructions are executed by a processor, each process of the foregoing embodiment of the video editing method is implemented, with the same technical effect achieved. To avoid repetition, details are not described herein again.

The processor is a processor in the electronic device in the foregoing embodiment. The readable storage medium includes a computer-readable storage medium, such as a computer ROM, an RAM, a magnetic disk, or an optical disc.

In addition, an embodiment of this application provides a chip. The chip includes a

processor and a communication interface. The communication interface is coupled to the processor. The processor is configured to run a program or instructions to implement each process of the foregoing embodiment of the video editing method, with the same technical effect achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a storage medium, and the program product is executed by at least one processor to implement each process of the foregoing embodiment of the video editing method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, or may be implemented by using hardware. In some embodiments, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A video editing method, comprising:
receiving a first input performed by a user to a video playback interface of a first video;
displaying a first identifier in response to the first input, wherein the first identifier indicates a first video clip in the first video;
receiving a second input performed by the user; and
storing the first identifier in response to the second input.

2. The video editing method according to claim 1, wherein before receiving the first input performed by the user to the video playback interface of the first video, the method further comprises:
receiving a third input performed by the user to an identification control; and
making the first video in an editable state in response to the third input.

3. The video editing method according to claim 1, wherein the first input comprises a first sub-input and a second sub-input;
receiving the first input performed by the user to the video playback interface of the first video comprises:
receiving the first sub-input performed by the user to a first image frame in the first video and the second sub-input performed by the user to a second image frame in the first video; and
displaying the first identifier in response to the first input comprises:
displaying a start marker point in response to the first sub-input; and
displaying an end marker point and the first identifier in response to the second sub-input, wherein
the first video clip is a video clip between the first image frame and the second image frame, and the first identifier is determined based on the start marker point and the end marker point.

4. The video editing method according to claim 3, wherein after displaying the end marker point and the first identifier, the method further comprises:
receiving a fourth input performed by the user to a target marker point, wherein the target marker point comprises at least one of the following: the start marker point or the end marker point; and
updating, in response to the fourth input, a location of the target marker point and the first video clip indicated by the first identifier.

5. The video editing method according to claim 1, wherein after displaying the first identifier, the method further comprises:
receiving a fifth input performed by the user to the first identifier; and
displaying a first editing window of the first video clip in response to the fifth input, wherein the first editing window is used to update video parameter information of the first video clip.

6. The video editing method according to claim 5, wherein the first editing window comprises at least one of the following controls: a filter control, a text control, or a background music control, wherein the filter control is used to update filter information of the first video clip, the text control is used to update text information of the first video clip, and the background music control is used to update background music of the first video clip.

7. The video editing method according to claim 1, wherein storing the first identifier comprises:
storing, in an identification folder in an album, a first identification thumbnail corresponding to the first identifier.

8. The video editing method according to claim 7, wherein the identification folder further comprises a second identification thumbnail corresponding to a second identifier, and the second identifier is used to indicate a second video clip in the first video, wherein video image frames in the second video clip are different from video image frames in the first video clip, or video image frames in the second video clip are partially the same as video image frames in the first video clip.

9. The video editing method according to claim 7, wherein after storing, in the identification folder in the album, the first identification thumbnail corresponding to the first identifier, the method further comprises:
receiving a sixth input performed by the user to the identification folder;
displaying P identification thumbnails and a video editing control in response to the sixth input, wherein the P identification thumbnails comprise the first identification thumbnail, and P is a positive integer;
receiving a seventh input performed by the user to the video editing control; and
displaying a video editing interface in response to the seventh input.

10. The video editing method according to claim 9, wherein the video editing interface comprises a first display area and a second display area, the first display area comprises at least one video thumbnail, each video thumbnail corresponds to a video clip, and the second display area comprises at least one identification thumbnail; and
after displaying the video editing interface, the method further comprises:
receiving an eighth input performed by the user to a target video thumbnail of the at least one video thumbnail, and receiving a ninth input performed by the user to a target identification thumbnail of the at least one identification thumbnail;
displaying the target video thumbnail and the target identification thumbnail in a third display area of the video editing interface in response to the eighth input and the ninth input, wherein an arrangement order of the target video thumbnail and the target identification thumbnail is in an association relationship with the eighth input and the ninth input; and
generating a target video based on a third video clip corresponding to the target video thumbnail and a fourth video clip corresponding to the target identification thumbnail.

11. The video editing method according to claim 10, wherein after displaying the target video thumbnail and the target identification thumbnail in the third display area of the video editing interface, the method further comprises:
receiving a tenth input performed by the user to the third display area; and
updating display information of the third display area in response to the tenth input, wherein the display information comprises at least one of the following: a quantity of target video thumbnails, locations of target video thumbnails, a quantity of target identification thumbnails, or locations of target identification thumbnails.

12. The video editing method according to claim 7, wherein after storing, in the identification folder in the album, the first identification thumbnail corresponding to the first identifier, the method further comprises:
receiving an eleventh input performed by the user to the first identification thumbnail; and
displaying a target interface in response to the eleventh input, wherein
the target interface comprises video parameter information of the first video clip.

13. The video editing method according to claim 12, wherein after displaying the target interface, the method further comprises:
receiving a twelfth input performed by the user; and
updating target information in response to the twelfth input, wherein the target information comprises at least one of the following: the video parameter information of the first video clip, or the first video clip.

14. The video editing method according to claim 1, further comprising:
receiving a thirteenth input performed by the user to the video playback interface of the first video; and
displaying S identifiers of the first video in response to the thirteenth input, wherein each identifier indicates a video clip in the first video, and S is a positive integer.

15. The video editing method according to claim 14, wherein after displaying the S identifiers of the first video, the method further comprises:
receiving a fourteenth input performed by the user to a target identifier of the S identifiers; and
displaying, in response to the fourteenth input, a second editing window of a fifth video clip indicated by the target identifier, wherein the second editing window is used to update video parameter information of the fifth video clip.

16. An electronic device, comprising: a processor; and a memory a computer program or an instruction stored thereon, wherein the computer program or the instruction, when executed by the processor, causes the processor to perform operations comprising:
receiving a first input performed by a user to a video playback interface of a first video;
displaying a first identifier in response to the first input, wherein the first identifier indicates a first video clip in the first video;
receiving a second input performed by the user; and
storing the first identifier in response to the second input.

17. The electronic device according to claim 16, wherein before receiving the first input performed by the user to the video playback interface of the first video, the operations further comprise:
receiving a third input performed by the user to an identification control; and
making the first video in an editable state in response to the third input.

18. The electronic device according to claim 16, wherein the first input comprises a first sub-input and a second sub-input;
receiving the first input performed by the user to the video playback interface of the first video comprises:
receiving the first sub-input performed by the user to a first image frame in the first video and the second sub-input performed by the user to a second image frame in the first video; and
displaying the first identifier in response to the first input comprises:
displaying a start marker point in response to the first sub-input; and
displaying an end marker point and the first identifier in response to the second sub-input, wherein
the first video clip is a video clip between the first image frame and the second image frame, and the first identifier is determined based on the start marker point and the end marker point.

19. The electronic device according to claim 18, wherein after displaying the end marker point and the first identifier, the operations further comprise:
receiving a fourth input performed by the user to a target marker point, wherein the target marker point comprises at least one of the following: the start marker point or the end marker point; and
updating, in response to the fourth input, a location of the target marker point and the first video clip indicated by the first identifier.

20. A non-transitory computer readable storage medium storing a computer program or an instruction that, when executed by a processor, causes the processor to perform operations comprising:
receiving a first input performed by a user to a video playback interface of a first video;
displaying a first identifier in response to the first input, wherein the first identifier indicates a first video clip in the first video;
receiving a second input performed by the user; and
storing the first identifier in response to the second input.
